(19) United States
(12) Patent Application Publication
(10) Pub. No.: US 2002/0108463 A1
(43) Pub. Date: Aug. 15, 2002

(54) Magneto-rheological brake pedal feel emulator

(75) Inventors: Schuyler Scott Shaw, Dayton, OH (US); Ernst S. Baumgartner, Dayton, OH (US)

Correspondence Address: SCOTT A. MCBAIN, DELPHI TECHNOLOGIES, INC., Legal Staff Mail Code: 480-414-420, P.O. Box 5052, Troy, MI, 48007-5052, US

(73) Assignee: Delphi Technologies, Inc.

(21) Appl. No.: 09/780,277

(22) Filed: Feb. 9, 2001

(51) Int. Cl. G05G 1/14

(52) U.S. Cl. 74/512

(57) ABSTRACT

An emulator affixed to a brake arm connected to a brake pedal of an electric brake system is capable of emulating a hydraulic brake. The emulator includes a housing defining a fluid chamber containing a magneto-rheological (MR) fluid. A piston is slideably disposed within the piston chamber and a spring biases the piston to resist depression of the brake pedal. A magnetic source generates a magnetic field upon the MR fluid thereby increasing the sheer resistance of the MR fluid further resisting depression of the brake pedal emulating a hydraulic brake system. The amount of resistance can be varied according to the strength of the magnetic field exerted on the MR fluid.

### TECHNICAL FIELD

The subject invention relates to an improved electrical brake system. More specifically, the subject invention relates to an improved brake pedal feel emulator for an electrical brake system.

### BACKGROUND OF THE INVENTION

The introduction of electrical brake systems to motor vehicles, often referred to as “brake by wire” systems, has proven to be an acceptable alternative to conventional hydraulic brake systems. A brake by wire system is even preferable in some case due to the reduction in mass when compared with a conventional system. A brake by wire system is preferable to a hydraulic brake system on an electric vehicle due to the necessity to reduce mass, the absence of hydraulics, and the ability to integrate the system into the vehicle's electronic circuits.

One problem with a brake by wire system is the different feel the brake pedal gives to the vehicle operator. A typical hydraulic system will exert a counter force on the brake pedal during depression due to the hydraulic pressure in the system hydraulic lines. Because the brake by wire system does not have any associated hydraulic pressure, the operator will not detect any counter force. The absence of counter force could be disorienting for the vehicle operator making it difficult for the operator to bring the vehicle to a smooth stop.

A typical brake by wire system includes a feel emulator designed to emulate the feel of a hydraulic brake system for the operator. Two types of emulators are currently utilized. The first is a spring piston that provides counteractive force to the depression of the brake pedal. The spring piston merely provides a linear counteractive force and does not provide the operator with any feedback as to the amount of stopping force that is being applied by the brakes. A second type of emulator is a hydraulic emulator that offers an improved emulation of a hydraulic brake system. However, it is preferable to remove all of the hydraulics from a motor vehicle, otherwise the mass savings realized by the brake by wire system will not be derived.

Therefore, it would be desirable to introduce an emulator to a brake by wire system that produces counter forces to a brake pedal representative of the forces generated by a hydraulic brake system that does not itself make use of hydraulics.

### SUMMARY OF THE INVENTION

The subject invention is an improved brake pedal assembly for use with an electric brake system for a motor vehicle. The assembly includes a pedal affixed to the end of a pedal arm. An emulator is operatively connected to the pedal arm for emulating a hydraulic brake assembly. The emulator includes a housing defining a piston chamber containing magneto-rheological (MR) fluid. A piston is disposed inside the piston chamber and is affixed to a piston shaft having a distal end located outside of the housing. A spring is disposed inside the piston chamber for biasing the piston shaft into the housing. The piston includes an electric coil capable of generating a magnetic field upon the MR fluid. The magnetic field increases the sheer resistance of the MR fluid thereby increasing the resistance to the piston stroking inside the piston chamber.

The Sheer force of the MR fluid is controlled by the amount of magnetic force that is generated by the electric coil. Various types of sensors may be used to determine the amount of travel and force applied to the brake pedal. Thus, the subject emulator can be tuned to match precisely the amount of counteracting force expected from a hydraulic brake system. Because the subject emulator does not require hydraulics, it does not counteract the mass savings derived from the brake by wire system. Further, the ability to vary the amount of sheer resistance in the MR fluid allows for a variable amount of resistance to the piston, which a spring piston is unable to do.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a side view of the brake pedal assembly showing the inventive emulator;

FIG. 2 is a sectional view of the inventive emulator;

FIG. 3 is a side view of the brake pedal assembly showing alternative sensor locations; and

FIG. 4 is a side view of the brake pedal assembly showing a further alternative sensor location.

### DESCRIPTION OF THE PREFERRED EMBODIMENT

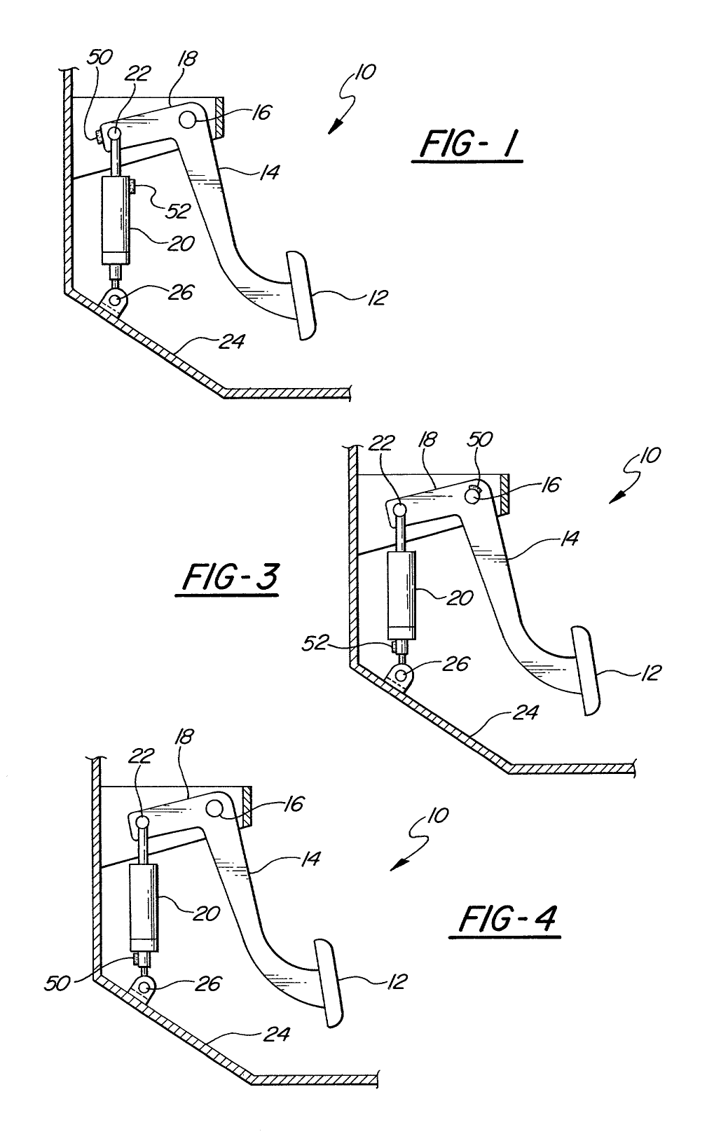

Referring to FIG. 1, a brake pedal assembly for a motor vehicle is generally shown at 10. The brake pedal assembly 10 includes a brake pedal 12 affixed to the end of a pedal arm 14. The pedal arm 14 is typically suspended from an instrument panel (not shown) by a pivot pin 16. A connector arm 18 is affixed to the pedal arm 14 proximate to the pivot pin 16 so that depression of the brake pedal 12 cantilevers the connector arm 18 in an upwardly direction. An emulator 20 is affixed at one end to the connector arm 18 with a connector pin 22 and at an opposite end to a vehicle body 24 with a vehicle pin 26. The connector pin 22 and the vehicle pin 26 allows the emulator 20 to pivot with respect to both the connector arm 18 and the vehicle body 24. As will be explained further below, depressing the brake pedal 12 causes expansion forces to be exerted on the emulator 20.

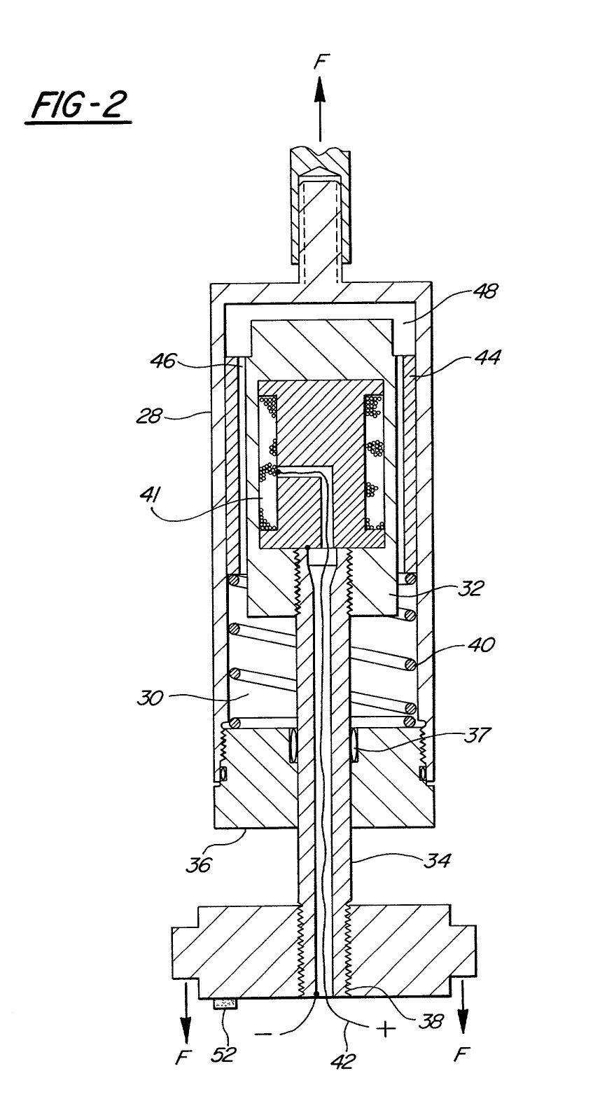

Referring now to FIG. 2, the emulator 20 includes a housing 28 that defines a fluid chamber 30. Magneto-rheological (MR) fluid is disposed within the fluid chamber 30. When subjected to a magnetic field, the MR fluid's sheer characteristics change from a Newtonian fluid to a Bingham plastic. The sheer resistance of the MR fluid when subjected to a magnetic field increase relative to the strength of a magnetic field the MR fluid is subjected to.

A piston 32 is disposed within the fluid chamber 30. The piston 32 is affixed to a piston shaft 34 that protrudes through a cap 36 enclosing the fluid chamber 30. A shaft seal 37 is received by the cap 36 and circumscribes the piston shaft 34 for preventing the MR fluid from leaking out of the fluid chamber 30. A distal end 38 of the piston shaft 34 extends outside of the fluid chamber 30. A spring 40 is disposed within the fluid chamber 30 and biases the piston 32 to retract the piston shaft 34 into the housing 28.

A coil 41 is disposed inside the piston and is aligned coaxially with the piston shaft 34. An electrical wire 42 runs through the piston shaft 34 to provide electric current to the coil 41. When the electric coil 41 is charged, a magnetic field is emitted from the coil.

A sleeve 44 circumscribes the piston 32 defining an annular opening 46 therebetween. The MR fluid flows through the annular opening 46 where it is subjected to the full force of the magnetic field generated by the coil 40. The piston 32 separates the MR fluid inside the fluid chamber 30 from an air chamber 48. The MR fluid flows through the annular opening 46 when the piston shaft 34 is forced out of the housing 28 upon depressing the brake pedal 12. Preferably, the air chamber 48 is oriented above the piston 32 when the emulator 20 is installed in the vehicle. Therefore, when the brake pedal 12 is released and the piston shaft 34 is retracted into the housing 28, pressure generated by the piston 32 and the spring 40 will force the MR fluid out of the air chamber 48 downward through the annular opening 46.

The air chamber 48 is pressurized with air during assembly of the emulator 20. The air chamber 48 also provides space for the expansion of the MR fluid when the emulator 20 is subjected to high temperatures. Because the air chamber 48 is oriented above the piston 32, an air dome will form above the MR fluid inside in the air chamber 48. As the piston shaft 34 retracts into the housing, the pressure of the air dome, along with the gravitational forces, will force the MR fluid back through the annular opening 46, thereby removing all of or most of the MR fluid from the air chamber 48.

The MR fluid being forced through the annular opening 46 when the brake pedal 12 is being depressed resists the stroking action of the piston 32 inside the housing 28. The strength of the magnetic field on the MR fluid in the annular opening 46 determines the amount of sheer resistance in the MR fluid that resist the stroking action of the piston 32. If the magnetic field is very high, a significant amount of sheer resistance will resist the stroking action of the piston 32. If the strength of the magnetic field is low, the resistance to the stroking action of the piston 32 will be low.

The strength of the magnetic field exerted on the MR fluid is determined by the amount of electrical current flowing to the coil 40. A controller (not shown) determines the level of electrical current based on information received from a travel sensor 50. The travel sensor can be located in any one of several locations on the assembly 10, each of which will function equally well. As shown in FIG. 1, the travel sensor 50 is located on the pedal arm 14 to determine the travel distance of the pedal arm 14 upon depression of the brake pedal 12. Further, as shown in FIG. 3, the travel sensor 50 can be positioned on the pivot pin 16 to measure the amount of pivot of the pedal arm 14 when the brake pedal 12 is depressed. Still further, as shown in FIG. 4, the travel sensor 50 can be located on the emulator 20 to measure the amount of axial travel of the piston shaft 34. Upon receipt of the travel distance from the travel sensor 50, the controller will determine the amount of electric current to deliver to the coil 40 so that the emulator 20 will emulate the feel of a hydraulic brake system relative to the amount of force being exerted upon the brake pedal 12.

A force sensor 52 is included with the assembly 10 to form a closed information loop with the controller for establishing a more accurate emulation of a hydraulic brake system. The force sensor 52 can be located at the distal end 38 of the piston shaft 34 as shown in FIG. 2. As shown in FIG. 1, the force sensor 52 can also be located on the housing to measure the forces the housing 28 is subjected to. Alternatively, the force transducer 50 can also be affixed to the piston shaft 34 to measure the tensile load on the piston shaft 34 as shown in FIG. 3.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

1. A brake pedal assembly for use with an electric brake system for a motor vehicle comprising:
a pedal;
a pedal arm;
an emulator operatively connected to said pedal arm for emulating a hydraulic brake assembly;
said emulator comprising:
a housing defining a piston chamber having magneto-rheological (MR) fluid disposed therein;
a piston disposed inside said piston chamber and being affixed to a piston shaft having distal end disposed outside said housing;
a spring disposed inside said piston chamber for biasing said piston; and
said piston including an electric coil capable of generating a magnetic field upon said MR fluid wherein said magnetic field increases the sheer resistance of said MR fluid thereby increasing resistance to said piston stroking inside said piston chamber.

2. An assembly as set forth in claim 1 including an electric wire disposed inside said piston shaft for supplying electrical current to said coil.

3. An assembly as set forth in claim 2 including a cap enclosing said housing having said piston shaft inserted therethrough.

4. An assembly as set forth in claim 3 wherein said cap includes a housing seal for sealing said piston cap to said housing.

5. An assembly as set forth in claim 4 wherein said cap includes a shaft seal for sealing said cap to said shaft.

6. An assembly as set forth in claim 1 wherein said distal end of said piston shaft is pivotally affixed to the vehicle and said housing is pivotally affixed to said pedal arm.

7. An assembly as set forth in claim 1 wherein depression of said brake pedal telescopes said piston shaft out of said piston chamber.

8. An assembly as set forth in claim 1 wherein said piston separate an MR fluid chamber from an air chamber inside said piston chamber.

9. An assembly as set forth in claim 8 wherein said piston includes a sleeve defining a fluid passage circumscribes said coil allowing MR fluid to pass between said MR chamber and said air chamber.

10. An assembly as set forth in claim 1 wherein said spring biases said piston to retract said piston shaft in to said housing.

11. An assembly as set forth in claim 10 wherein said electric coil is aligned coaxially with said piston shaft.

12. An assembly as set forth in claim 1 wherein said emulator includes a travel sensor determining the distance of travel and velocity of said pedal thereby controlling the amount of magnetic field generated by said electrical coil.

13. An assembly as set forth in claim 12 wherein said emulator includes a force sensor determining the amount of force exerted upon said pedal thereby controlling the amount of magnetic field generated by said electrical coil.

14. An assembly as set forth in claim 13 wherein said travel sensor and said force sensor signal a controller to determine the amount of electrical current distributed to said electrical coil.

15. An emulator affixed to a brake arm connected to a brake pedal of an electric brake system being capable of emulating a hydraulic brake system comprising:
a housing defining a fluid chamber having magneto-rheological (MR) fluid disposed therein;
a piston slideably disposed within said piston chamber;
a magnetic source generating a magnetic field upon said MR fluid thereby increasing the sheer resistance of said MR fluid for further resisting depression of said brake pedal and emulating a hydraulic brake system.

16. An emulator as set forth in claim 15 wherein said magnetic source comprises an electric coil receiving electric current in response to depression of the brake pedal.

17. An emulator as set forth in claim 16 wherein said electric coil is disposed within said piston.

18. An emulator as set forth in claim 17 wherein said piston includes an annular fluid passage concentrically aligned around said electric coil allowing said MR fluid to flow therethrough for receiving the magnetic field generated by said electric coil.

19. An emulator as set forth in claim 18 wherein said piston separates an air chamber from said fluid chamber.

20. An emulator as set forth in claim 19 including an electric wire disposed within said piston for supplying electric current to said electric coil.

21. An emulator as set forth in claim 15 including a spring disposed inside said fluid chamber biasing said piston to resist depression of said brake pedal.

22. A method of emulating the feel of a hydraulic brake system on a electric brake system comprising the steps of:
providing an emulator having magneto-rheological (MR) fluid disposed therein and being operably connected to the electric brake system;
supplying a magnetic field inside the emulator upon the MR fluid thereby increasing the shear resistance of the MR fluid;
generating the feel of a hydraulic brake system with sheer resistance derived from the MR fluid subjected to the magnetic field.

23. A method as set forth in claim 22 wherein said step of generating the feel of a hydraulic brake system is further defined by resting the stoking action of a piston disposed inside the emulator.

24. A method as set forth in claim 22 further including the step of supplying electrical current to said emulator for generating the magnetic field.
